(19) United States
(12) Patent Application Publication
(10) Pub. No.: US 2020/0086264 A1
(43) Pub. Date: Mar. 19, 2020

(54) Method for enhancing anti-oxidation activity of a solution containing gold nanoclusters binding with ligands and its making process

(71) Applicant: GOLDRED NANOBIOTECH CO., LTD., Taoyuan City (TW)

(72) Inventors: Hong Shong Chang, Taoyuan City (TW); Cheng-An Lin, Taoyuan City (TW); Zih-Yun Huang, Miaoli County (TW); Yun-Yu Chen, New Taipei City (TW); Kuan-Jung Li, Tainan City (TW); Juin-Hong Cherng, Taipei City (TW); Wei-Chung Lai, New Taipei City (TW)

(21) Appl. No.: 16/689,280

(22) Filed: Nov. 20, 2019

Related U.S. Application Data
(63) Continuation-in-part of application No. 15/460,649, filed on Mar. 16, 2017.
(60) Provisional application No. 62/378,303, filed on Aug. 23, 2016.

(51) Int. Cl. B01D 53/00; C09K 11/58; B82Y 30/00; B82Y 40/00

(52) U.S. Cl. CPC B01D 53/007; C09K 11/58; B01D 2259/804; B82Y 40/00; B82Y 30/00

(57) ABSTRACT

A method for enhancing anti-oxidation activity of a solution containing gold nanoclusters binding with ligands and its making process are disclosed, The method for enhancing anti-oxidation activity of a solution containing gold nanoclusters binding with ligands comprises: Treat a solution containing gold nanoclusters binding with ligands by UV light, and a wavelength range of the UV light is 300˜400 nm.

### CROSS REFERENCE TO RELATED APPLICATIONS

This application is a Continuation In Part of applicant's earlier application Ser. No. 15/460,649, filed Mar. 16, 2017

### BACKGROUND OF THE INVENTION

### 1. Field of the Invention

The present invention generally relates to a method for enhancing anti-oxidation activity of a solution containing gold nanoclusters binding with ligands and its making process.

### 2. Description of the Prior Art

In modern biological analysis, various kinds of organic dyes are used. However, with each passing year, more flexibility is being required of these dyes, and the traditional dyes are often unable to meet the expectations. To this end, semiconductor quantum dots have quickly filled in the role, being found to be superior to traditional organic dyes on several counts, one of the most immediately obvious being brightness (owing to the high quantum yield) as well as their stactivity (much less photo-bleaching).

The use of semiconductor quantum dots for highly sensitive cellular imaging has seen major advances over the past decade. The improved photostactivity of semiconductor quantum dots for example, allows the acquisition of many consecutive focal-plane images that can be reconstructed into a high-resolution three-dimensional image. Another application that takes advantage of the extraordinary photostactivity of quantum dot probes is the real-time tracking of molecules and cells over extended periods of time.

Semiconductor quantum dots have also been employed for in vitro imaging of pre-labeled cells. The activity to image single-cell migration in real time is expected to be important to several research areas such as embryogenesis, cancer metastasis, stem-cell therapeutics, and lymphocyte immunology.

But there is a remaining issue with semiconductor quantum dot probes containing toxic ions, such as Cadmium and Lead. For this reason, we have been used fluorescent gold nanoclusters, so-called gold-quantum dots, instead of semiconductor quantum dots, wherein gold-quantum dots is nontoxic, having biocompatibility and high fluorescence quantum yield. Moreover, it is confirmed that gold-quantum dots is able to process different fluorescence colors by changing size thereof.

However, it is really difficult to synthesize gold-quantum dots. Gold-quantum dots are from PAMAM-encapsulated Au generally, wherein the PAMAM dendrimer is costly and gold-quantum dots are unable to be mass production at once.

Therefore, in view of the above mentioned problems, a novel process for preparing gold-quantum dots and also the related derivatives is an important research topic in industry.

### SUMMARY OF THE INVENTION

According to the aforementioned, the present invention mainly discloses a novel method for enhancing anti-oxidation activity of a solution containing gold nanoclusters binding with ligands and its making process to fulfill the requirements of this industry.

One object of the present invention is to disclose a novel method for enhancing anti-oxidation activity of a solution containing gold nanoclusters binding with ligands. The method comprises a step of treating a solution containing gold nanoclusters binding with ligands by UV light.

Representatively, a process for making the solution containing gold nanoclusters binding with ligands comprises following steps: (1) Provide an aqueous solution that comprises a gold precursor, a base and ligands; wherein the gold precursor comprises Au(III) ions; the base comprises NaOH or KOH; and the ligands is lipoic acid or dihydrolipoic acid; (2) perform a reduction reaction at room temperature by adding a reductant into the aqueous solution to form a liquid containing gold nanoclusters binding with the ligands; (3) concentrate the liquid containing the gold nanoclusters binding with the ligands to a solid at 30-60° C.; (4) dissolve the solid with water to form a crude solution; and (5) perform a purification process by passing the crude solution through a membrane or a dialysis tube to obtain the solution containing the gold nanoclusters binding with the ligands.

In particular, a specific wavelength range of the UV light uses for the purpose of enhancing anti-oxidation activity of the solution containing the gold nanoclusters binding with the ligands. Typically, the wavelength range of the UV light is 300˜400 nm. Preferably, the wavelength range of the UV light is 300˜310 nm.

Another object of the present invention is to provide a process for making a solution containing the gold nanoclusters binding with ligands with stable anti-oxidation activity.

Representatively, a process for making the solution containing gold nanoclusters binding with ligands with stable anti-oxidation activity comprises following steps: (1) Provide an aqueous solution that comprises of a gold precursor, a base and ligands; wherein the gold precursor comprises Au(III) ions; the base comprises NaOH or KOH; and the ligands is lipoic acid or dihydrolipoic acid; (2) perform a reduction reaction at room temperature by adding a reductant into the aqueous solution to form a liquid containing gold nanoclusters binding with the ligands; (3) concentrate the liquid containing the gold nanoclusters binding with the ligands to a solid at 30-60° C.; (4) dissolve the solid with water to form a crude solution; (5) perform a purification process by passing the crude solution through a membrane or a dialysis tube to obtain the solution containing the gold nanoclusters binding with the ligands; and (6) treat the solution containing gold nanoclusters binding with ligands by UV light to obtain the solution containing gold nanoclusters binding with ligands with stable anti-oxidation activity.

The aforementioned anti-oxidation activity is measured by DPPH assay, as a result, the anti-oxidation activity is also equal to free radicals scavenging activity.

In particular, a specific wavelength range of the UV light uses for the purpose of stabilizing anti-oxidation activity of the solution containing the gold nanoclusters binding with the ligands. Typically, the wavelength range of the UV light is 300˜400 nm. Preferably, the wavelength range of the UV light is 300˜310 nm.

In conclusion, the invention discloses a method for enhancing anti-oxidation activity of a solution containing gold nanoclusters binding with ligands by UV light treatment and its making process. The process is a one-batch process. A key feature of the invention process is to make the gold nanoclusters binding with the ligands with excellent anti-oxidation activity when compared to traditional process. Furthermore, the process also provides the gold nanoclusters binding with the ligands with stable and lasting anti-oxidation activity. Secondly, the invention process only uses water as the medium, so the process is an environmental-friendly process. Moreover, the gold nanoclusters binding with the ligands prepared by the invention process do not contain any harmful or toxic solvents such as toluene or dimethylformamide; as a result, the gold nanoclusters binding with the ligands with stable anti-oxidation activity prepared by the invention process are very suitable for cosmetic and medical applications.

### BRIEF DESCRIPTION OF THE DRAWINGS

FIG. 1 is the TEM photo of the solution containing gold nanoclusters binding with lipoic acid ligands of the example 1 in the present invention;

FIG. 2 is the TEM photo of the single gold nanocluster binding with lipoic acid ligands of the example 1 in the present invention;

FIG. 3 is the core size distribution of the gold nanoclusters binding with lipoic acid ligands of the example 1 in the present invention; FIG. 3 is calculated from FIG. 2 by software;

FIG. 4 is the size distribution by number of the gold nanoclusters binding with lipoic acid ligands; FIG. 4 is measured by DLS;

FIG. 5 is the size distribution by volume of the gold nanoclusters binding with lipoic acid ligands; FIG. 5 is measured by DLS;

FIG. 6 illustrates the relation between fluorescent strength of the gold nanoclusters binding with lipoic acid ligands and heating temperature

FIG. 7 illustrates the relation between fluorescent strength of the gold nanoclusters binding with lipoic acid ligands and UV treatment; and

FIG. 8 illustrates the relation between fluorescent strength of the gold nanoclusters binding with lipoic acid ligands and the concentration of the solution containing the gold nanoclusters binding with lipoic acid ligands

### DESCRIPTION OF THE PREFERRED EMBODIMENTS

What is probed into the invention is a fluorescent gold nanocluster and method for forming the same. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following specification. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

A first embodiment of the present invention discloses a novel method for enhancing anti-oxidation activity of a solution containing gold nanoclusters binding with ligands.

The method comprises a step of treating the solution containing gold nanoclusters binding with ligands by UV light.

In a representative example of the first embodiment of the present invention, a process for making the solution containing gold nanoclusters binding with ligands comprises following steps: (1) Provide an aqueous solution that comprises a gold precursor, a base and ligands; wherein the gold precursor comprises Au(III) ions; the base comprises NaOH or KOH; and the ligands is lipoic acid or dihydrolipoic acid; (2) perform a reduction reaction at room temperature by adding a reductant into the aqueous solution to form a liquid containing gold nanoclusters binding with the ligands; (3) concentrate the liquid containing the gold nanoclusters binding with the ligands to a solid at 30-60° C.; (4) dissolve the solid with water to form a crude solution; and (5) perform a purification process by passing the crude solution through a membrane or a dialysis tube to obtain the solution containing the gold nanoclusters binding with the ligands.

In a representative example of the first embodiment, a specific wavelength range of the UV light uses for the purpose of enhancing anti-oxidation activity of the solution containing the gold nanoclusters binding with the ligands. Typically, the wavelength range of the UV light is 300˜400 nm. More preferably, the wavelength range of the UV light is 300˜310 nm.

In a most preferred example of the first embodiment, the wavelength of the UV light is about 302 nm.

In one preferred example of the first embodiment, the process further comprises performing a heating process and/or a UV treatment to increase the fluorescent strength of the solution containing the gold nanoclusters binding with the ligands.

In one example of the first embodiment, the heating process is performed at a temperature between 30 and 150° C.

In one example of the first embodiment, the Au(III) ions are from AuCl₃ or HAuCl₄.

In one example of the first embodiment, the mole ratio of the gold precursor to the ligands is less than 10.

In one example of the first embodiment, the reductant is selected from one of the group consisting of Sodium borohydride, Dithiothreitol, ascorbic acid and glutathione. Preferably, the reductant is Sodium borohydride.

In one example of the first embodiment, the reduction reaction is performed at the room temperature which is 5-40° C.

In one example of the first embodiment, the purification process is applied for keeping nanoclusters having a molecular weight between 10 and 100 kDa.

In one example of the first embodiment, the gold nanoclusters binding with ligands are characterized with a Fourier transform infrared spectrum comprising bands at 3261, 2920, 2852, 1560 and 1401 cm⁻¹.

In one example of the first embodiment, the gold nanoclusters binding with ligands are characterized with an X-ray powder diffraction pattern comprising peaks at 38.5° (111), 44.6° (200), 64.8° (220), and 77.8° (311) 2-theta degree.

In one example of the first embodiment, the gold nanoclusters binding with ligands have a hydrodynamic diameter average size between 1 and 4 nm.

In one example of the first embodiment, the gold nanoclusters binding with the ligands have a weight ratio of gold to the ligands between 0.5 and 10.

In one example of the first embodiment, the gold nanoclusters binding with the ligands, being a part of one comprises cosmetic composition, food composition and pharmaceutical composition.

A second embodiment of the present invention is to provide a process for making a solution containing the gold nanoclusters binding with ligands with stable and lasting anti-oxidation activity.

In a representative example of the second embodiment of the present invention, the process for making the solution containing gold nanoclusters binding with ligands with stable and lasting anti-oxidation activity comprises following steps: (1) Provide an aqueous solution that comprises a gold precursor, a base and ligands; wherein the gold precursor comprises Au(III) ions; the base comprises NaOH or KOH; and the ligands is lipoic acid or dihydrolipoic acid; (2) perform a reduction reaction at room temperature by adding a reductant into the aqueous solution to form a liquid containing gold nanoclusters binding with the ligands; (3) concentrate the liquid containing the gold nanoclusters binding with the ligands to a solid at 30-60° C.; (4) dissolve the solid with water to form a crude solution; (5) perform a purification process by passing the crude solution through a membrane or a dialysis tube to obtain the solution containing the gold nanoclusters binding with the ligands; and (6) treat the solution containing gold nanoclusters binding with ligands by UV light to obtain the solution containing gold nanoclusters binding with ligands with stable anti-oxidation activity.

In a representative example of the second embodiment, a specific wavelength range of the UV light uses for the purpose of stabilizing anti-oxidation activity of the solution containing the gold nanoclusters binding with the ligands. Typically, the wavelength range of the UV light is 300˜400 nm. More preferably, the wavelength range of the UV light is 300˜310 nm.

In a most preferred example of the second embodiment, the wavelength of the UV light is about 302 nm.

In one example of the second embodiment, the Au(III) ions are from AuCl₃ or HAuCl₄.

In one example of the second embodiment, the mole ratio of the gold precursor to the ligands is less than 10.

In one example of the second embodiment, the reductant is selected from one of the group consisting of Sodium borohydride, Dithiothreitol, ascorbic acid and glutathione. Preferably, the reductant is Sodium borohydride.

In one example of the second embodiment, the reduction reaction is performed at the room temperature which is 5-40° C.

In one example of the second embodiment, the purification process is applied for keeping nanoclusters having a molecular weight between 10 and 100 kDa.

In one example of the second embodiment, the gold nanoclusters binding with ligands are characterized with a Fourier transform infrared spectrum comprising bands at 3261, 2920, 2852, 1560 and 1401 cm⁻¹.

In one example of the second embodiment, the gold nanoclusters binding with ligands are characterized with an X-ray powder diffraction pattern comprising peaks at 38.5° (111), 44.6° (200), 64.8° (220), and 77.8° (311) 2-theta degree.

In one example of the second embodiment, the gold nanoclusters binding with ligands have a hydrodynamic diameter average size between 1 and 4 nm.

In one example of the second embodiment, the gold nanoclusters binding with the ligands have a weight ratio of gold to the ligands between 0.5 and 10.

In one example of the second embodiment, the gold nanoclusters binding with the ligands, being a part of one comprises cosmetic composition, food composition and pharmaceutical composition.

### Example 1: A General Process for Preparing a Solution Containing Gold Nanoclusters Binding with Lipoic Acid Ligands

30 μmol of lipoic acid was dissolved in DI water containing sodium hydroxide. 10 μmol of gold (III) chloride trihydrate was added under stirring at room temperature. Sodium borohydride was added as reducing agent, and then the mixture was stirred for 15 hrs at room temperature. The reaction mixture was concentrated to solid under 55° C., then dissolve by DI water to form crude solution. Free or excess lipoic acid in crude solution was purified or removed by applying 10 kDa membrane filtration device. A solution containing gold nanoclusters binding with lipoic acid ligands was prepared.

The gold nanoclusters binding with lipoic acid ligands prepared by the procedure described in example 1 are characterized by Transmission electron microscopy (TEM), dynamic light scattering (DLS), X-ray photoelectron spectroscopy (XPS), thermogravimetric analysis (TGA), Fourier transform infrared spectrometer (FTIR) and X-ray diffraction (XRD).

The typical parameters of the gold nanoclusters binding with lipoic acid ligands prepared by the procedure described in example 1 are listed in TABLE 1.

TABLE 1

| Parameter | Method | Results | |
|---|---|---|---|
| Size of gold core | TEM | 1.45 ± 0.34 | nm |
| Average Size by | DLS | 2.27 ± 0.45 | nm |
| number | | | |
| Shape | TEM | Sphere | |
| Surface | XPS | Atom(%): C(73.9%); O(17.0%) | |
| chemistry | | S(4.4%); Na(2.7%); | |
| | | N(1.3%); Au(0.6%) | |
| Surface charge | Zeta-potential | −55.4 ± 2.9 | mV |
| Chemical | TGA/FTIR_{(Dry sample)} | Gold core: 67.39% | |
| composition | | Lipoic acid: 32.61% | |
| Gold | ICP-MS | 1560 | ppm |
| concentration in | | | |
| the solution | | | |

| | | |
|---|---|---|
| Purity | ICP-MS | 99.81% |
| Crystal structure | XRD | Cubic |
| Partition | ICP-MS | logP (_{octanol/water}): −1.10 |
| coefficient | | |

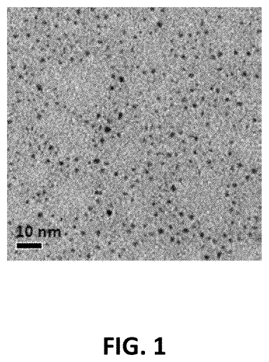

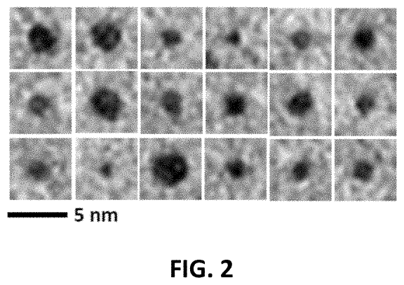

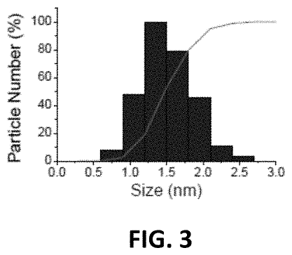

As shown in FIG. 1 and FIG. 2, TEM analysis show that the gold nanoclusters binding with lipoic acid ligands has a size less than 10 nm and well dispersed in the aqueous solution. FIG. 3 indicated that the gold nanoclusters binding with lipoic acid ligands have an average core diameter being 1.45+0.34 nm.

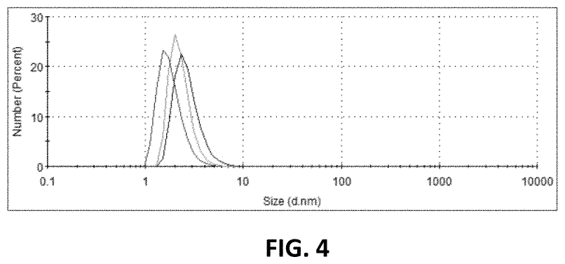

As shown in FIG. 4, DLS analysis showed the size distribution by number for 3 lots of the gold nanoclusters binding with lipoic acid ligands. The data is 1.82 nm with standard deviation of 0.56 nm, 2.28 nm with standard deviation of 0.60 nm, and 2.71 nm with standard deviation of 0.89 nm, respectively.

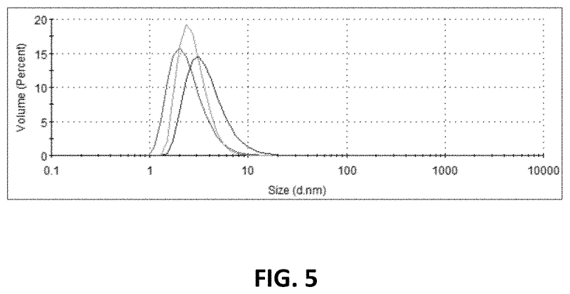

As shown in FIG. 5. DLS analysis showed the size distribution by volume for 3 lots of the gold nanoclusters binding with lipoic acid ligands. The data is 2.56 nm with standard deviation of 1.44 nm, 2.80 nm with standard deviation of 0.96 nm, and 4.00 nm with standard deviation of 2.16 nm, respectively.

X-ray photoelectron spectroscopy showed the atom percent of C, O, S, Na, N and Au is 73.9%, 17.0%, 4.4%, 2.7%, 1.3%, 0.6% respectively.

Thermogravimetric analysis showed the weight percent of the gold and the ligands is 67.39% and 32.61%.

Fourier transform infrared spectrum indicated bands at 3261, 2920, 2852, 1560 and 1401 cm⁻¹.

X-ray diffraction showed diffraction pattern with four distinct diffraction peaks at 38.5° (111), 44.6° (200), 64.8° (220), and 77.8° (311)

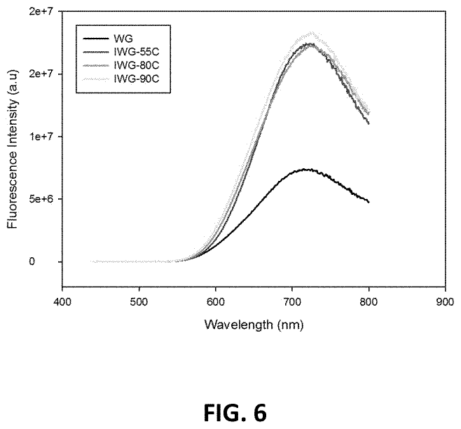

As shown in FIG. 6, WG represents the invention process without performing concentrating procedure; IWG-55C [symbol] IWG-80C and IWG-90C represents the invention process with performing the concentrating procedure and a further heating procedure at 55° C. [symbol] 80° C. and 90° C. respectively. Obviously, the heating procedure is able to increase the fluorescent strength of the gold nanoclusters binding with lipoic acid ligands at wavelength of 700 nm.

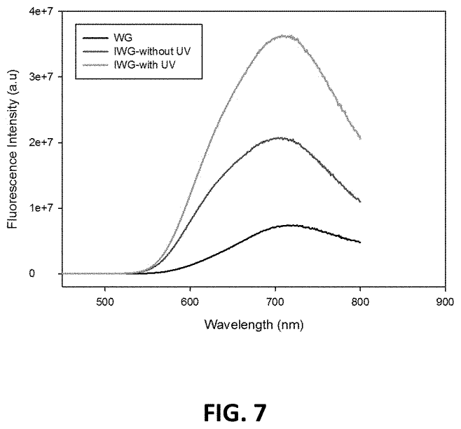

As shown in FIG. 7, WG represents the invention process without performing concentrating procedure; IWG-UV represents the invention process with performing the concentrating procedure and a further UV treatment at 365 nm. Obviously, the UV treatment is able to increase the fluorescent strength of the gold nanoclusters binding with lipoic acid ligands at wavelength of 700 nm.

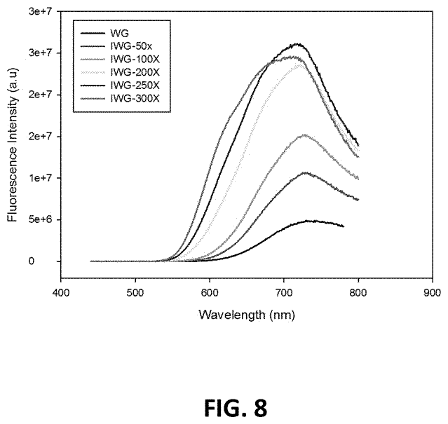

As shown in FIG. 8, WG represents the invention process without performing concentrating procedure; IWG-50X [symbol] IWG-100X [symbol] IWG-200X [symbol] IWG-250X and IWG-300X represent the invention process with performing concentrating procedure to increase the concentration of the gold nanoclusters binding with lipoic acid ligands to 50 folds [symbol] 100 folds [symbol] 200 folds [symbol] 250 folds and 300 folds of the original concentration respectively. When the concentration of the gold nanoclusters binding with lipoic acid ligands increases, the fluorescent intensity increases. For the purpose to maximize the fluorescent strength of the gold nanoclusters binding with lipoic acid ligands, the invention process have to concentrate the liquid containing the gold nanoclusters binding with the ligands to a solid and dissolve the solid again for further purification. Accordingly, the solid state after the claimed concentrating step is a key in the present invention.

### Example 2: The Evaluation of Anti-Oxidation Activity of the Gold Nanoclusters Binding with Lipoic Acid Ligands by DPPH Assay

To determine what wavelength (λ) range of UV light is able to effectively enhance anti-oxidation activity of the gold nanoclusters binding with the lipoic acid or dihydrolipoic acid ligands, we use three different UV light wavelengths including 254 nm, 302 nm and 365 nm to treat the gold nanoclusters binding with the lipoic acid or dihydrolipoic acid ligands for different times/periods and then measure DPPH assay of the gold nanoclusters binding with the lipoic acid or dihydrolipoic acid ligands, respectively. The DPPH assay measurement is described as follows. The entire course of the DPPH experiment needs to be done in full darkness, a preparation of 0.2 mM of DPPH was dissolved in methanol, then using the shaker to mix, the gold nanoclusters binding with lipoic acid ligands obtained according to the process described in example 1 were tested in a one-to-four ratio with DPPH, and the absorbance was measured at 517 nm by Spectrophotometry. The reaction time set before testing was 3 hours, and the DPPH radical was calculated according to the following formula.

$$\% inhibition of DPPH radical = [ \frac{{Abs}_{control} - ( {Abs}_{sample 1} - {Abs}_{sample 2} )}{{Abs}_{control}} ] \times 100$$

The Absₛₐₘₚₗₑ₁ is the absorbance of the DPPH with samples (the gold nanoclusters binding with the lipoic acid or dihydrolipoic acid ligands), Absₛₐₘₚₗₑ₂ is the absorbance of methanol with samples and Abs_{control} is the absorbance of the DPPH with water at 517 nm.

The aforementioned DPPH assay experimental results are shown as in Table 1.

TABLE 1

| | UV wavelength | | | | | |
|---|---|---|---|---|---|---|
| DPPH assay | 365 nm | 365 nm | 302 nm | 302 nm | 254 nm | 254 nm |
| 0 hr (No UV/Control) | 51.80684 | 49.87109 | 45.09921 | 39.86948 | 46.86769 | 45.27595 |
| 0.5 hr (UV treating time) | 50.24528 | 52.69528 | 54.32387 | 52.53523 | 43.98581 | 44.20572 |
| 1 hr (UV treating time) | 50.23274 | 52.73082 | 53.89714 | 52.52388 | 44.93247 | 44.11775 |
| 3 hr (UV treating time) | 53.45621 | 53.53982 | 54.80962 | 54.13774 | 42.39617 | 42.97422 |
| 6 hr (UV treating time) | 56.45182 | 56.66086 | 58.03734 | 54.99347 | 43.60463 | 43.26324 |
| 12 hr (UV treating time) | 56.6734 | 57.75416 | 61.601 | 57.60607 | 44.65811 | 42.63283 |
| 24 hr | 52.85625 | 54.7711 | 54.62803 | 55.84013 | 45.86238 | 39.79075 |

According to Table 1, obviously, UV 254 nm neither enhances anti-oxidation activity (DPPH assay) of the gold nanoclusters binding with the lipoic acid or dihydrolipoic acid ligands nor stabilizes anti-oxidation activity (DPPH assay) of the gold nanoclusters binding with the lipoic acid or dihydrolipoic acid ligands. UV 365 nm and UV 302 nm are able to enhance anti-oxidation activity (DPPH assay) of the gold nanoclusters binding with the lipoic acid or dihydrolipoic acid ligands at different treating time. In particular, UV 302 nm is able to enhance anti-oxidation activity (DPPH assay) of the gold nanoclusters binding with the lipoic acid or dihydrolipoic acid ligands within only 0.5 treating hour and also stabilizes anti-oxidation activity (DPPH assay) of the gold nanoclusters binding with the lipoic acid or dihydrolipoic acid ligands for 24 hours. Hence, a specific wavelength range of UV light being 300˜310 nm is very useful for enhancing anti-oxidation activity (DPPH assay) of the gold nanoclusters binding with the lipoic acid or dihydrolipoic acid ligands and also stabilizes and lasts anti-oxidation activity (DPPH assay) of the gold nanoclusters binding with the lipoic acid or dihydrolipoic acid ligands.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

1. A method for enhancing anti-oxidation activity of a solution containing gold nanoclusters binding with ligands, comprising: a step of treating a solution containing gold nanoclusters binding with ligands by UV light, and a wavelength range of the UV light is 300˜400 nm.

2. The method of claim 1, wherein the solution containing gold nanoclusters binding with ligands being made by steps comprise:
(1) Providing an aqueous solution that comprises a gold precursor, a base and ligands; wherein the gold precursor comprises Au(III) ions;
the base comprises NaOH or KOH; and the ligands is lipoic acid or dihydrolipoic acid; (2) performing a reduction reaction at room temperature by adding a reductant into the aqueous solution to form a liquid containing gold nanoclusters binding with the ligands;
(3) concentrating the liquid containing the gold nanoclusters binding with the ligands to a solid at 30-60° C.; (4) dissolving the solid with water to form a crude solution; and (5) performing a purification process by passing the crude solution through a membrane or a dialysis tube to obtain the solution containing the gold nanoclusters binding with the ligands.

3. The method of claim 1, wherein the wavelength range of the UV light is 300˜310 nm.

4. The method of claim 2, the steps further comprise performing a heating process and/or a UV treatment to increase the fluorescent strength of the solution containing the gold nanoclusters binding with the ligands.

5. The method of claim 4, the heating process is performed at a temperature between 30 and 150° C.

6. The method of claim 2, wherein the Au(III) ions are from AuCl₃ or HAuCl₄.

7. The method of claim 2, wherein the mole ratio of the gold precursor to the ligands is less than 10.

8. The method of claim 2, wherein the reductant is selected from one of the group consisting of Sodium borohydride, Dithiothreitol, ascorbic acid and glutathione.

9. The method of claim 2, wherein the reduction reaction is performed at the room temperature which is 5-40° C.

10. The method of claim 2, wherein the purification process is applied for keeping nanoclusters having a molecular weight between 10 and 100 kDa.

11. The method of claim 1, wherein the gold nanoclusters binding with ligands are characterized with a Fourier transform infrared spectrum comprising bands at 3261, 2920, 2852, 1560 and 1401 cm⁻¹.

12. The method of claim 1, wherein the gold nanoclusters binding with ligands are characterized with an X-ray powder diffraction pattern comprising peaks at 38.5° (111), 44.6° (200), 64.8° (220), and 77.8° (311) 2-theta degree.

13. The method of claim 1, wherein the gold nanoclusters binding with ligands have a hydrodynamic diameter average size between 1 and 4 nm.

14. The method of claim 1, wherein the gold nanoclusters binding with the ligands have a weight ratio of gold to the ligands between 0.5 and 10.

15. The method of claim 1, wherein the gold nanoclusters binding with the ligands, being a part of one comprises cosmetic composition, food composition and pharmaceutical composition.

16. A process for making a solution containing gold nanoclusters binding with ligands with stable anti-oxidation activity comprises following steps: (1) Providing an aqueous solution that comprises a gold precursor, a base and ligands; wherein the gold precursor comprises Au(III) ions; the base comprises NaOH or KOH; and the ligands is lipoic acid or dihydrolipoic acid; (2) performing a reduction reaction at room temperature by adding a reductant into the aqueous solution to form a liquid containing gold nanoclusters binding with the ligands; (3) concentrating the liquid containing the gold nanoclusters binding with the ligands to a solid at 30-60° C.; (4) dissolving the solid with water to form a crude solution; (5) performing a purification process by passing the crude solution through a membrane or a dialysis tube to obtain the solution containing the gold nanoclusters binding with the ligands; and (6) treating the solution containing gold nanoclusters binding with ligands by UV light to obtain the solution containing gold nanoclusters binding with ligands with stable anti-oxidation activity, and a wavelength range of the UV light is 300˜400 nm.

17. The method of claim 16, wherein the wavelength range of the UV light is 300˜310 nm.

18. The method of claim 16, wherein the Au(III) ions are from AuCl₃ or HAuCl₄.

19. The method of claim 16, wherein the mole ratio of the gold precursor to the ligands is less than 10.

20. The method of claim 16, wherein the reductant is selected from one of the group consisting of Sodium borohydride, Dithiothreitol, ascorbic acid and glutathione.

21. The method of claim 16, wherein the reduction reaction is performed at the room temperature which is 5-40° C.

22. The method of claim 16, wherein the purification process is applied for keeping nanoclusters having a molecular weight between 10 and 100 kDa.

23. The process of claim 16, wherein the gold nanoclusters binding with the ligands have a weight ratio of the gold to the ligands between 0.5 and 10.
